(19) United States
(12) Patent Application Publication
(10) Pub. No.: US 2015/0083985 A1
(43) Pub. Date: Mar. 26, 2015

(54) Method and System for Operating Winches and Use Thereof

(71) Applicant: I.P. HUSE AS, Harøy (NO)

(72) Inventor: Arnstein Lervik, Haroy (NO)

(73) Assignee: I.P. Huse AS, Harøy (NO)

(21) Appl. No.: 14/387,594

(22) PCT Filed: Mar. 27, 2013
(86) PCT No.: PCT/NO2013/000012

§ 371 Date: Sep. 24, 2014

(30) Foreign Application Priority Data
Mar. 27, 2012 (NO) 20120375

(51) Int. Cl. B63B 21/22; B66D 1/48; B66D 1/12; B66D 1/22; B63B 21/16; B66D 1/08

(52) U.S. Cl. CPC B63B 21/22; B63B 21/16; B66D 1/08; B66D 1/12; B66D 1/22; B66D 1/48
USPC 254/340

(57) ABSTRACT

This publication discloses a method and a winch system for powering a winch handling loads at an end of a line associated with a winch drum, the winch being powered by means of one or more electric motors and one or more hydraulic motors via a gear, in that said one or more hydraulic motors are operated when the load in the line exceeds a predetermined load level for taking care of quick hauling in or paying out the line to compensate for vertical motion of the winch, for example vessel due to waves, and the output shaft(s) of said one or more hydraulic motors are connected to the drum shaft through combination of a sun wheel, planet wheels and parallel wheels. Both a system and use of the invention are disclosed.

### THE TECHNICAL FIELD OF THE INVENTION

The present invention relates to a method and a winch system for operating winches, in particular electrical winches. The invention relates also to a preferred used. In particular the invention relates to a method for powering a winch on a vessel handling loads at an end of a line associated with a winch drum, the winch being powered by means of one or more electric motors and one or more hydraulic motors via a gear system. The invention also relates to a system for powering a winch handling loads.

A preferred use of the inventive method and system is also disclosed.

### BACKGROUND FOR THE INVENTION

Electrically driven winches are commonly driven by means of motors based on alternating current (AC) or direct current (DC) at a relatively high number of revolutions per minutes, for example 2000 revolutions per minutes, and with a relatively low torque.

For winches having a high pulling capacity, this implies that a gear must be arranged between the winch drum and the motor and that the gear must have a relatively high gear or transmission ratio. The total mass moment of inertia of the gear and the motor will result in a winch having a “stiff” characteristic, i.e. that the winch will have low sensitivity for variation in loads.

To have a winch that is sensitive to load variations is of importance for winches onboard for example anchor chain handling vessels where the load often may be stuck in the seabed while the vessel simultaneously moves up and down, following the motion of the sea. With a “stiff” winch the tension in the steel wire may quickly increase and representing a risk for the steel wire or the associated jointing elements to break, or at least causing damage to the winch and associated gear.

Winches onboard anchor handling vessels are mots commonly powered by hydraulic motors producing a relatively high torque and operating at low revolutions per minutes.

This may imply that the gear or transmission ratio within the gears between the winch drum and the motors may be relatively low. In addition, for such hydraulic motors the control of the appearing torque may quickly be achieved if the appearing load exceeds the torque that the motors are designed to handle. The load control may easily be adjusted from zero to the maximum capacity by means of the winch control system. With such solution the winch will be very sensitive for variations in load in the steel wire out from the drum. If the winch works against an object that is stuck in the seabed, the winch characteristic will be “soft”, so that the winch quickly will pull steel wire in or out as the vessel moves up and down du to waves.

JP 2009-269693 discloses a rope winch on a tug boat, capable of imparting back tension according to advancing speed of the tugboat. The rope winch includes a drum for winding a rope and an electric motor for rotating and driving the drum in a rope delivering direction or a rope winding direction. Moreover the winch includes a drum control unit for performing an inverter control of the electric motor to control rotation of the drum and a gear box arranged between the electric motor and the drum. The winch also includes a hydraulic tank and a hydraulic motor interlocked and connected with the gear box, a flow passage switching valve for switching a flow passage of hydraulic fluid and a relief valve and is also provided with a hydraulic circuit incorporated in the gear box. The drum control unit makes the hydraulic motor function as a resistor by switching a flow passage of hydraulic fluid by means of the flow passage switching valve when the drum is rotated in the drum delivering direction.

### OBJECTS OF THE PRESENT INVENTION

It is an object of the present invention to provide a new winch system with an improved gear box for electrically driven winches, in order to improve the dynamic properties of the winch system during operation.

Another object of the present invention is providing a winch system that over-comes the drawbacks of both electrically and hydraulically powered prior art winches.

### THE PRESENT INVENTION

The above objects are achieved by means of a winch system as defined in the independent method claim, characterized in that the one or more hydraulic motors are operated when the load in the line exceeds a predetermined load level for taking care of quick hauling in or paying out the line to compensate for vertical motion of the winch, for example due to waves, and the output shaft(s) of said one or more hydraulic motors are connected to the drum shaft through combination of a sun wheel, planet wheels and parallel wheels.

The preferred embodiments, variants and alternatives are defined by the dependent method claims 2-5.

The system of the present invention is defined in the independent claim 6 and in the dependent claims 7-10.

The system and a method as described is preferred used in a winch system that is installed and/or used in association with an anchor handling vessel, handling a load that is stuck in the sea bed while the vessel moves due to waves

One advantage of the winch system according to the present invention is that the risk for breaking the wire due to handling a load element, is eliminated, or at least substantially reduces.

The hydraulic loop must have installed sufficient cooling capacity to be able to transport away generated heat. This will reduce the need for taking care of the regenerative effect or braking effect from the electromotor in the electrical supply system onboard the vessel.

Such hybrid solution will in addition to the described way of operation also provide redundancy to the operation of the winch system. This implies that if there should be a break-down in the electrical motor system, the load may be hoisted by means of the hydraulic motor system. Correspondingly, in case of a break-down of the hydraulic motor system, the electrical motors may be used.

The system according to the present invention is well suited for use in case a load such as an anchor or a chain have got stick in the sea bed and required large forces from freeing them off the sea bed, while the vessel at the same time moves because of surface sea.

The system and method according to the present invention, i.e. the combination of electrical and hydraulic motors in association with the specified gear box provide improved properties and improved load regulation control on the gear box. This is achieved by using the combination of planet gears and the annulus gear solution.

Since many of the modern vessels are provided with heavy duty diesel-electrical systems and thus have a surplus of electrical energy available, it may be appropriate to also use such energy to power the winches.

### SHORT DESCRIPTION OF THE DRAWINGS

In the following an embodiment of the invention shall be described in further detail to enable the skilled person to understand the invention, wherein:

FIG. 1 shows schematically a diagram of ne embodiment of the gear system according to the present invention, showing the various essential parts of the winch system according to the invention; and

FIG. 2 shows schematically a vertical through the gear box, seen along the line A-A in FIG. 1.

### DETAILED DESCRIPTION OF THE EMBODIMENTS AS SHOWN IN THE FIGURES

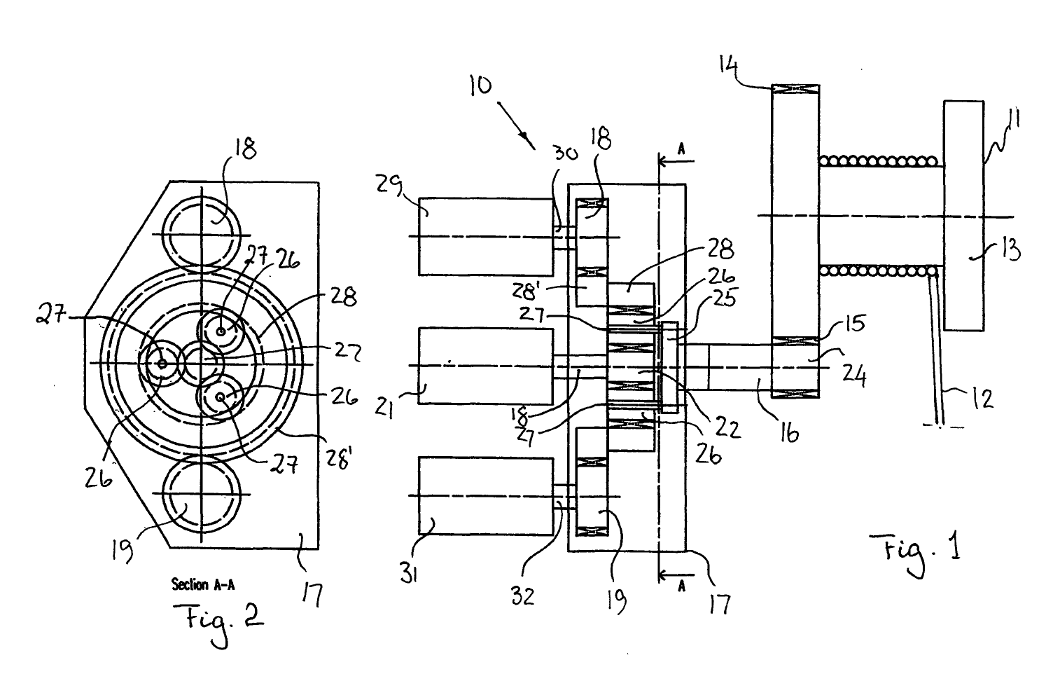

FIG. 1 shows schematically a diagram of one embodiment of the winch system 10 showing the various essential parts of the winch system 10 according to the invention. It should be appreciated that essential elements such as bearings for rotating input shafts 30, 18, 32 and rotating output shaft 16 are not shown. Moreover, the gear box housing is only schematically shown. It is apparent for the skilled person in the art that several types of bearings may be used. Given the total applicable rotational speeds and expected design load impact in the system the skilled person will know how to dimension and design such bearings and the surrounding housing of the gear box 17.

Moreover, it should also be appreciated that that the power for driving the drum is both electric and hydraulic power, the energy sources and the control and circuit for delivery of such energy is not shown.

The winch system 10 comprises a winch drum 11, rotatable arranged on a shaft (not shown) that preferably is horizontally arranged. Sufficient length of a rope or a wire 12 is wound up on the drum 11. One of the sides the drum 11 is provided with cut teeth 14 along the periphery of the drum side, projecting radially, the edges of the teeth 14 being aligned parallel with axis of rotation of the drum 11. Said teeth 14 mesh together with the teeth 15 a gear wheel 24 rigidly fixed at the end of an output shaft 16 of a gear box 17. The shaft 16 is parallel with the axis of rotation of the drum 11, and rotation of the output shaft 16 correspondingly rotates the drum 11.

On the opposite side of the gear box 17, three input shafts 30, 18 and 32 lead into the gear box 17 for providing the required torque to the output shaft 16, and consequently the drum, either for paying out or winding in wire 12.

A central input rotatable shaft 18 is driven by a hydraulic motor 21 and the opposite end of the shaft 18 is provided with a sun wheel (gear) 22. The shaft 18 and the sun wheel 22 form a rigid and an integrated unit and rotate in parallel with the drum 12 and aligned with the rotational axis of drive wheel 24.

In order to transfer torque from the hydraulic motor 21 to the drum 11 via the sun wheel 22 and the drive wheel 24 at the end of output shaft 16, the opposite end of the output shaft 16 (leading into the gear box 17) is provided with a rigidly fixed disc 25. The disc 25 may for example have a circular shape or may be formed as wings, arranged perpendicular on the axis of the output shaft 16.

As shown in FIG. 1, three planet wheels 26 are rotatable arranged on three separate shafts 27, the shafts 27 being rigidly fixed to the disc 25 or wings fixed to the output shaft 16.

Moreover, the axis of rotation of each of the planet wheels 26 is parallel with the axis of the output shaft 18, the drum 11 and the sun wheel 22. The planet wheels are also provided with cut teeth being are in mesh engagement with the teeth on the sun wheel 22.

Moreover, the planet wheels 26 are also in mesh contact with a rotatable arranged annulus 28 which is provided with cut teeth arranged along the interior annulus surface. The annulus 28 rotates around an axis which is aligned with the axis of the sun wheel 22, the disc 25 and the output axis 16, while it is in parallel with the drum rotational axis and the planet wheels 27. The annulus 28 is moreover provided with an additional annulus 28′ rigidly fixed to the annulus 28 meshed with the planet wheels 26, thus rotating around the same axis of rotation. The additional annulus 28′ is provided with cut teeth arranged around the entire periphery of the additional annulus 28′, and they are in mesh contact with the gear wheel 18 on a shaft 30 of a first electric motor 29.

Further the winch system 10 is also provided with a second electric motor 31 the shaft 32 of which being rigidly connected to a gear wheel 19 with cut teeth. Both gear wheels 18 and 19 are in mesh contact the external toothed surface of the second annulus 28′.

FIG. 2 shows schematically a vertical section of the gear box, seen along the line A-A in FIG. 1.

### The Winch System 10 According to the Present Invention Functions as Follows:

In general, the method according is characterized in that the winch drum 11 is driven by one or more electric motors 29, 31 combined with one or more hydraulically powered hydraulic motors 21 via a gear box 17. The winch drum 11 is driven by said three motors 21, 29 and 31 via a common output shaft 16 being interconnected through the gear box 17. The gear wheel 24 rigidly fixed to the shaft 16 drives the winch drum 11 for paying out or winding in the load carrying wire, line or chain 12.

The hydraulic motor 21 is in idling engagement with the gearbox 17 and the output shaft 16 when system is powered by the electric motors 29, 31. In this stage the sun wheel is passive free rotating. The hydraulic motor does not start producing torque until the load in the wire 12 becomes higher than a predefined upper load limit.

The hydraulic motor provides a proper torque control through the shaft 18 driving the planet wheels 26 and imposing rotation to the annulus 28, while the electric motors 29, 31 are meshed with the outer annulus 28′, forming an integral part with the inner annulus 28. The output shaft 16 from the gear box 17 is fixed to the disc 25 carrying the shafts 27 for the planet wheels 26.

The mesh ratio between the gear wheel 24 on the output shaft 16 and the sun wheel 22 on the shaft 18 of the hydraulic motor 21 is relatively low, for example in a range of 1:5. The corresponding mesh ratio between the gear wheel 24 on the output shaft 18 and annulus 28, 28′ is relatively high, for example in a range of 1:50. During normal operation the sun wheel 22 is locked from rotation, while the planet wheels 26 rotate freely around the locked sun wheel 22.

During this normal operation the electrical motors 29, 31 are powered, rotating the wheels 18, 19, bringing the annulus 28, 28′ to rotate and hence transferring torque on to the output shaft 16 through the planet wheels 26 that are rotating and causing rotation of the disc 25 supporting the planet wheels 26.

The torque is controlled by means of the winch control system and is based on valves exerting pressure regulation in the hydraulic motor 21.

The torque control on the hydraulic motor 10 is set to a predefined load level so that the hydraulic motor is idling as long the required torque is below said predefined or set load value. If the pull or load in the wire exceeds the preset level for the hydraulic motor 21, the hydraulic motor 21 is powered, starting to introduce torque into the gear box 17 shaft 16. This means that the winch 10 will pay out wire 12 from the drum 11 and thus minimize any possible detrimental build-up of tension in the winch drum wire 12. Thus, the hydraulic motor will function as a safety measure opening up when the tension in the wire approaches the pre-determined set value.

Moreover, the solution according to the present invention makes it possible to add the output from the electrical motors 29, 31 with the output from the hydraulic motor 21. This may in particular be of interest when deploying, since the hydraulic motor 21 may load deploy without having installed corresponding pumping effect. The effect generated is easily absorbed by means of a cooling circuit in the hydraulic system. Such a cooling circuit is simple and economical to calculate and dimension for absorbing the maximum effect of the hydraulic motor.

In conclusion, according to the present invention, the hydraulic motor 21 is coupled to the output shaft 16 via the sun wheel 22 of the planet gear, while the electro motors 29, 31 are coupled to the output shaft 16 via the outer gearwheel 28 of the planet gear. The output shaft 16 is connected to the planet carrier 25 of the planet gear. The hydraulic motor is connected all the time, but starts to operate only when the load of the line 12 becomes too high.

1. Method for powering a winch handling loads at an end of a line associated with a winch drum, the winch being powered by means of one or more electric motors and one or more hydraulic motors via a gear, characterised in that
said one or more hydraulic motors are operated when the load in the line exceeds a predetermined load level for taking care of quick hauling in or paying out the line to compensate for vertical motion of the winch, for example due to waves, and the output shaft(s) of said one or more hydraulic motors are connected to the drum shaft through combination of a sun wheel, planet wheels and parallel wheels.

2. Method according to claim 1, characterised in that the hydraulic motor (21) drives the output shaft (16) via the sun wheel (22) of the planet gear, while the electro motors (29, 31) drive the output shaft (16) via an outer gearwheel (28) of the planet gear.

3. Method according to claims 1-2, characterised in that the output shaft (16) is driven by connection to a planet carrier (25) of the planet gear.

4. Method according to claims 1-3, characterised in that hydraulic motor(s) is in idling engagement with the gearbox (17) and the output shaft (16), and starts exerting a torque power to the shaft (16) as the load of the line (12) exceeds a predetermined (set) load level value.

5. Method according to any of the preceding claims, characterised in that the gear ratio between an gear wheel on output shaft and the sun wheel is relatively low, in particular in a range of 1:5, while the gear ratio between the gear wheel on output shaft and an annulus gear driven by said one or more electric motor is relative high, in particular in a range of 1:50.

6. System for powering a winch handling loads at an end of a line associated with a winch drum, the winch being powered by means of one or more electric motors and one or more hydraulic motors via a gear, characterised in that
the system comprises one or more hydraulic motors arranged to be operated when the load in the line exceeds a predetermined load level for taking care of quick hauling in or paying out the line to compensate for vertical motion of the winch, for example vessel due to waves, and the output shaft(s) of said one or more hydraulic motors are connected to the drum shaft through combination of a sun wheel, planet wheels and parallel wheels.

7. System according to claim 6, characterised in that the hydraulic motor via its shaft is associated with a sun wheel in a planet gear, while one or more electric motors are associated with the annulus via sufficient gears, while the out put shaft from the gear box is associated with a planet wheel holder (25).

8. System according to any of claims 6-7, characterised in that the output shaft (16) is connected to a planet carrier (25) of the planet gear.

9. System according to any of claims 6-7, characterised in that hydraulic motor(s) is in idling engagement with the gearbox (17) and the output shaft (16), and is arranged to exerting a torque power to the shaft (16) as the load of the line (12) exceeds a predetermined (set) load level value.

10. System according to any of the preceding claims 6-9, characterised in that the gear ratio between an gear wheel on output shaft and the sun wheel is relatively low, in particular in a range of 1:5, while the gear ratio between the gear wheel on output shaft and an annulus gear driven by said one or more electric motor is relative high, in particular in a range of 1:50.

11. Use of a system and a method as described in one of the claims 1 to 6, where the winch system is installed and/or used in association with an anchor handling vessel, handling a load that is stuck in the sea bed while the vessel moves due to waves.
